(19) United States
(12) Patent Application Publication
(10) Pub. No.: US 2013/0209759 A1
(43) Pub. Date: Aug. 15, 2013

(54) Ornamentation Of Quartz Resin Composites

(71) Applicant: Gosakan Aravamudan, Bangalore (IN)

(72) Inventor: Gosakan Aravamudan, Bangalore (IN)

(21) Appl. No.: 13/700,134

(22) PCT Filed: May 25, 2011
(86) PCT No.: PCT/IN11/00359

§ 371 Date: Feb. 7, 2013

(30) Foreign Application Priority Data
May 28, 2010 (IN) 1462/CHE/2010

(51) Int. Cl. B32B 5/28

(52) U.S. Cl. CPC B32B 5/28
USPC 428/207; 156/63

(57) ABSTRACT

A method for decorating an artificial stone laminate, for example, a quartz resin composite is provided. In the manufacturing process, a substantially thin layer of transparent or translucent particulates is deposited on a release surface. Color pigments or any coloring material that imparts color and/or contrast are selectively deposited in areas on the transparent or translucent particulates to create patterns and designs. A layer of reinforcing fibers, for example, glass fibers, is placed on the layer of transparent or translucent particulates. A binder, deposited on the layer of reinforcing fibers, fills gaps between the transparent or translucent particulates and binds the reinforcing fibers to the transparent or translucent particulates. After the artificial stone laminate cures, the artificial stone laminate is polished to expose a flat, transparent or translucent surface of the transparent or translucent particulates that have been selectively colored by the coloring material to create visual patterns and designs.

### CROSS REFERENCE TO RELATED APPLICATIONS

This application claims the benefit of the following patent applications:

1. Provisional patent application No. 1462/CHE/2010 titled “Ornamentation Of Quartz Resin Composites”, filed on 28 May 2010 in the Indian Patent Office.

2. PCT application number PCT/IN2011/000359 titled “Ornamentation Of Quartz Resin Composites”, filed on 25 May 2011 in the Indian Patent Office.

The specifications of the above referenced patent applications are incorporated herein by reference in their entirety.

### BACKGROUND

This invention, in general, relates to building structures. More particularly, this invention relates to an architectural surface and body structure for furniture and building structures, for example, doors, tables, and windows.

Currently, decorative laminates and wood veneers are extensively used as architectural surfaces. In most cases, decorative laminates are manufactured from Kraft paper impregnated with phenolic resin. Wood and its derivatives are currently the preferred choice of material for surfacing furniture and building structures. Wood veneers and wood derived products such as laminates place a large burden on our already shrinking environmental resources.

Decorative laminates show scratches over prolonged use, and uncoated wood veneers absorb moisture and stain easily. If proper care is not taken, wood products have a limited life. Wood products may decay when exposed to moisture for long periods, and are prone to termite attacks. In tropical countries with excess rainfall, wood expands seasonally due to excess moisture content. As a result, doors and windows surfaced with wood or its derivatives get jammed within their frames.

A thin quartz resin composite is a substitute for wood composed or stone composed products in building and furniture applications. An example of a quartz resin composite is a thin quartz resin composite disclosed in PCT application number PCT/IN2010/000630 titled “Artificial Stone Laminate” filed on 20 Sep. 2010 in the Indian Patent Office. This thin quartz resin composite comprises a layer of quartz with a backing of glass fiber, in a polyester resin matrix. There is a need for improving aesthetics of the thin quartz resin composites.

There is a long felt but unresolved need for a method of decorating quartz resin composites by applying ornamental designs to the quartz resin composites.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method disclosed herein addresses the above stated need for decorating an artificial stone laminate, for example, a quartz resin composite, by applying ornamental designs to the quartz resin composite. In the manufacturing process, transparent or translucent particulates comprising, for example, quartz particles, are deposited in a substantially thin layer of, for example, about 2 mm on a release surface. The particulates comprise, for example, one or more of quartz particulates, metal pieces, transparent particulates coated with metal and colored glass, etc., and any combination thereof. A coloring material, for example, color pigments or any material that imparts color and/or contrast is selectively deposited in areas on the transparent or translucent particulates to create patterns or designs. A layer of reinforcing fibers, for example, glass fibers, is placed on the thin layer of transparent or translucent particulates. Further, a binder, for example, a polyester resin, an acrylic resin, etc., with or without a filler, is introduced in the layers containing the transparent or translucent particulates and the reinforcing fibers. The binder fills gaps between the transparent or translucent particulates and binds the reinforcing fibers to the transparent or translucent particulates. In an embodiment, vacuum and pressure is applied to the deposited binder, the thin layer of transparent or translucent particulates, and the layer of reinforcing fibers during and/or after the deposition of the binder. In an embodiment, the surface of the thin layer of transparent or translucent particulates is chemically modified for improving adhesion of the transparent or translucent particulates with the binder.

After the quartz resin composite cures, the quartz resin composite is polished to expose a flat, transparent or translucent surface of the transparent or translucent particulates that have been selectively colored by the coloring material to create visual patterns and designs.

The following methods may be used to selectively deposit the coloring material, for example, color pigments, phosphorescent pigments, metallic pigments, or any material that imparts color or contrast in areas on the transparent or translucent particulates to create patterns or designs.

In a first method, transparent or translucent particulates are deposited in a substantially thin layer of, for example, about 2 mm, on a release surface. A stencil with patterns and designs is placed on the deposited thin layer of transparent or translucent particulates. A resin mixed with the coloring material is sprayed over the stencil for selectively coloring the transparent or translucent particulates. A layer of reinforcing fibers, also referred to as a reinforcement layer, is then placed on the thin layer of transparent or translucent particulates sprayed with the coloring material. A binder is then deposited on the layer of reinforcing fibers for filling gaps between the transparent or translucent particulates and for binding the reinforcing fibers to the transparent or translucent particulates.

In a second method, transparent or translucent particulates are deposited and spread in a substantially thin layer of, for example, about 2 mm, on a release surface. A coloring material, for example, color pigments carried in a resin or a solvent medium is selectively deposited in patterns or designs on a glass fiber sheet. This glass fiber sheet comprising the selectively deposited coloring material is then placed over the deposited thin layer of transparent or translucent particulates. In an embodiment, an additional reinforcement layer is placed over the glass fiber sheet, after which a binder is introduced. The binder fills gaps between the transparent or translucent particulates and binds the reinforcing fibers to the transparent or translucent particulates.

Pigments are expensive. The above two methods of decorating an artificial stone laminate utilize a minimal amount of pigments, and advantageously reduce the manufacturing cost.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a decorative artificial stone laminate, showing a rear layer of reinforcing fibers backing a top layer of transparent or translucent particulates with a coloring material selectively deposited on the transparent or translucent particulates in the form of a floral design.

FIG. 2 exemplarily illustrates selective deposition of a coloring material on transparent or translucent particulates in the form of a floral design using a stencil and a spray.

FIG. 3 exemplarily illustrates a top orthogonal view of an artificial stone laminate decorated by selective deposition of a coloring material on transparent or translucent particulates in the form of a floral design using a stencil and a spray.

FIG. 4 exemplarily illustrates a glass fiber sheet selectively deposited with a coloring material carried in a resin in the form of a floral design.

FIG. 5 exemplarily illustrates a top orthogonal view of an artificial stone laminate decorated by placing a glass fiber sheet selectively deposited with a coloring material carried in a resin in the form of a floral design over a thin layer of transparent or translucent particulates.

FIGS. 6A-6B exemplarily illustrate methods for decorating an artificial stone laminate.

### DETAILED DESCRIPTION OF THE INVENTION

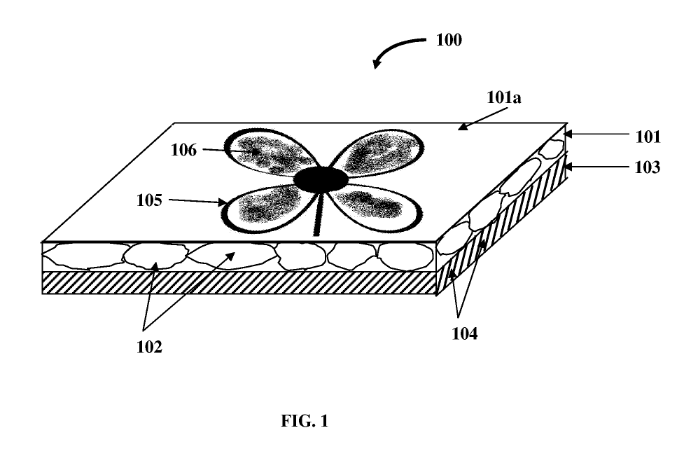

FIG. 1 exemplarily illustrates a decorative artificial stone laminate 100, showing a rear layer 103 of reinforcing fibers 104 backing a top layer 101 of transparent or translucent particulates 102 with a coloring material 106 selectively deposited on the transparent or translucent particulates 102 in the form of a floral design 105. The decorative artificial stone laminate 100 disclosed herein comprises a top layer 101 of particulates 102 comprising, for example, quartz particles, colored in one or more predetermined patterns or designs, for example, a floral design 105 as exemplarily illustrated in FIG. 1. The decorative artificial stone laminate 100 disclosed herein further comprises a rear layer 103 of reinforcing fibers 104 backing the particulates 102 and a binder binding the particulates 102 and the reinforcing fibers 104. The particulates 102 comprise, for example, one or more of quartz particulates, metal pieces, transparent particulates coated with metal and colored glass, etc., and any combination thereof. The reinforcing fibers 104 comprise, for example, glass fibers. The binder is, for example, a polyester resin, an acrylic resin, etc., with or without a filler.

The artificial stone laminate 100 disclosed herein is, for example, a decorative laminate comprising a visually decorative and functional surface covering. The decorative laminate is required to be thin and flexible to be used as an architectural surface covering, as heavier and thicker decorative laminates pose difficulty in adhering to substrates. Thicker and heavier decorative laminates may delaminate and warp over time. The artificial stone laminate 100 disclosed herein is a thin layer 101 of particulates 102 held by a binder. The artificial stone laminate 100 disclosed herein is lightweight and visually appeasing. Furthermore, since the artificial stone laminate 100 disclosed herein requires no more than a thin layer 101 of particulates 102, there is substantial reduction, for example, in cost, thickness, and weight resulting in a thin lightweight artificial stone laminate 100.

Disclosed herein is a method of ornamentation of an artificial stone laminate 100, for example, a quartz resin composite. In the manufacturing process, transparent or translucent particulates 102, for example, quartz particles are deposited in a substantially thin layer 101 of, for example, about 2 mm, on a release surface. A coloring material 106, for example, color pigments or any material that imparts color and/or contrast is selectively deposited in areas on the quartz particles to create patterns or designs 105. A layer 103 of reinforcing fibers 104, for example, glass fibers, may be placed on the thin layer 101 of quartz particles. Further, a binder, with or without a filler, is introduced in the layers 101 and 103 containing the quartz particles and the reinforcing fibers 104 respectively. In an embodiment, the binder comprises a pigment that differs from the pigment selectively deposited in areas on the quartz particles. After the quartz resin composite cures, the quartz particles are polished to expose a flat, transparent or translucent surface 101a of the quartz particles that have been selectively colored by the coloring material 106 to create visual patterns or designs 105. The single size of the particulates 102 is chosen, for example, between about 0.5 mm and about 3 mm. The size of the particulates 102 is chosen, for example, in the range of about 1.05 mm to about 1.95 mm. The particulates 102 are, for example, quartz particulates, or one or more of a combination of quartz particulates, metal pieces, and transparent particulates coated with metal and colored glass. The particulates 102 are preferably transparent quartz particulates.

The reinforcing fibers 104 comprise, for example, glass fibers. The reinforcing fibers 104 are, for example, a composite material made of a polymer matrix reinforced with fibers. The fibers are, for example, fiberglass, carbon, or aramid, while the polymer is, for example, an epoxy, vinyl ester or a polyester thermosetting plastic. The rear layer 103 of reinforcing fibers 104 is, for example, a chopped glass fiber mat. The layer 103 of reinforcing fibers 104 comprises, for example, one or more of glass fibers, polyester fibers, ceramic fibers, carbon fibers, aramid fibers, organic fibers, etc.

Furthermore, the translucent or transparent particulates 102 further comprise particles such as quartz, glass, and other decorative particles and objects. For the purpose of ornamentation, even a small amount of opaque particles such as metal, ceramic, stone, semiprecious stones, etc., may be deposited on the release surface along with the translucent or transparent particulates 102.

The binder is, for example, a polyester resin with a filler or an acrylic resin, etc. The binder used for filling gaps between the particulates 102 and for binding the reinforcing fibers 104 to the particulates 102 is, for example, a thermoset plastic such as a polyester resin, along with a filler. An example of a polyester resin is a combination of ortho neo pentyl glycol and styrene. Another example of a polyester resin is a combination of isophthalic neo pentyl glycol, methyl methyl acrylate, and styrene. Room temperature catalysts, for example, methyl ethyl ketone peroxide (MEKP) and room temperature accelerators may be used along with the binder for curing the binder. High temperature setting catalysts, for example, benzoyl peroxide (BPO) may also be used for curing the binder. The filler is a fine powder, for example, aluminum trihydrate, calcium carbonate, quartz powder, or a combination thereof. The use of aluminum trihydrate as a filler makes the artificial stone laminate 100 disclosed herein fire resistant.

The following methods may be used to selectively deposit the coloring material 106, for example, color pigments, phosphorescent pigments, metallic pigments, or any material that imparts color or contrast in areas on the particulates 102 to create patterns or designs 105.

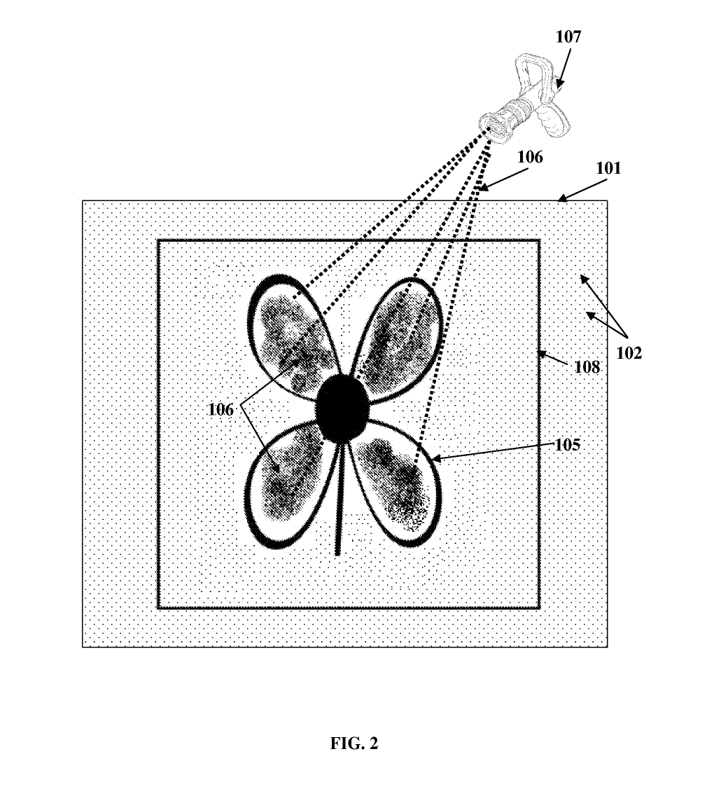

FIG. 2 exemplarily illustrates selective deposition of a coloring material 106 on transparent or translucent particulates 102 in the form of a floral design 105 using a stencil 108 and a spray 107. In this embodiment, transparent or translucent particulates 102, for example, quartz particles are deposited in a substantially thin layer 101 of, for example, about 2 mm, on a release surface. The release surface is, for example, a silicon rubber sheet, a Teflon® sheet of DuPont, a Mylar® sheet, etc. The release surface may also be treated with release coatings, for example, polyvinyl alcohol or silicone sprays. A stencil 108 with patterns or designs, for example, a floral design 105 as exemplarily illustrated in FIG. 2, is placed on the thin layer 101 of transparent or translucent quartz particles. A resin mixed with the coloring material 106, for example, a color pigment is sprayed over the stencil 108 using the spray 107 for selectively coloring the transparent or translucent quartz particles. A layer 103 of reinforcing fibers 104, as exemplarily illustrated in FIG. 1, is placed over the sprayed layer 101 of transparent or translucent quartz particles. A binder is then introduced in the layers 101 and 103 containing the quartz particles and the reinforcing fibers 104 respectively to bind the reinforcing fibers 104 to the transparent or translucent quartz particles.

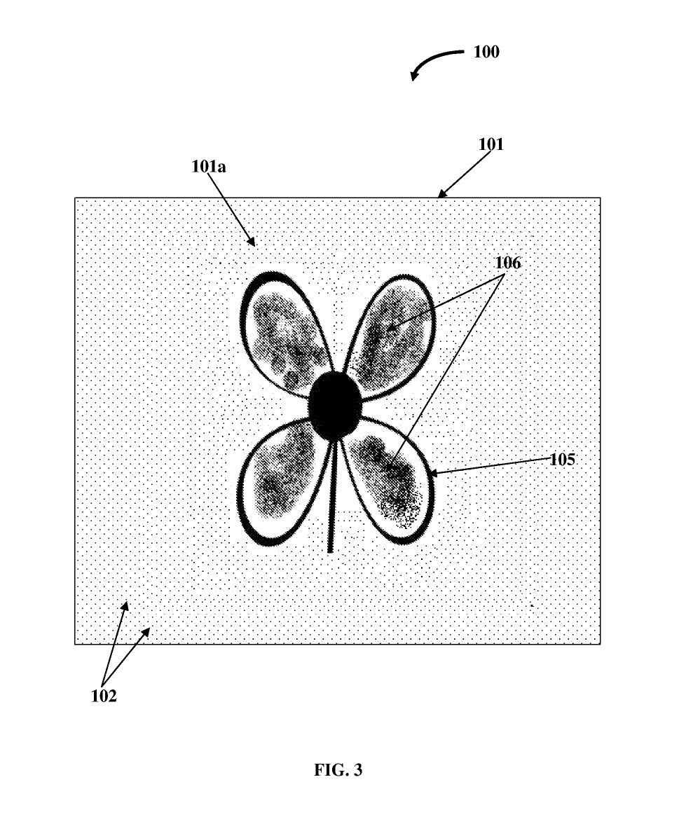

FIG. 3 exemplarily illustrates a top orthogonal view of an artificial stone laminate 100 decorated by selective deposition of a coloring material 106 on transparent or translucent particulates 102 in the form of a floral design 105 using a stencil 108 and a spray 107. After the binder fills gaps between the transparent or translucent particulates 102, for example, the quartz particles and binds the reinforcing fibers 104 to the transparent or translucent quartz particles, the transparent or translucent quartz particles are polished to expose a flat, transparent or translucent surface 101a of the transparent or translucent quartz particles that have been selectively colored by the coloring material 106 to create the floral design 105.

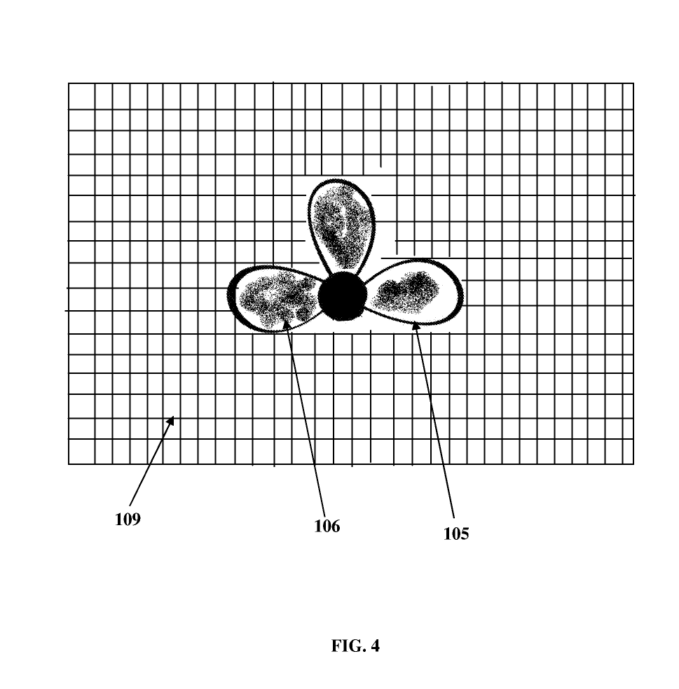

FIG. 4 exemplarily illustrates a glass fiber sheet 109 selectively deposited with a coloring material 106 carried in a resin in the form of a floral design 105. In this embodiment, a pigment carrier is used in a screen printing process, where the pigment carrier binds the coloring material 106, for example, color pigments to the glass fiber sheet 109. The pigment carrier is, for example, a resin or a solvent medium. In a second case, a pigment carrier is used in the screen printing process, where the pigment carrier does not permanently bind the color pigments to the glass fiber sheet 109. Optionally in the second case, the pigment carrier only deposits the color pigments at the respective locations on the glass fiber sheet 109. The color pigments are then temporarily bound to the glass fiber sheet 109. When a binder, for example, a polyester resin along with a monomer such as styrene, is deposited on the glass fiber sheet 109, the binder locally spreads the color pigments that were deposited on the glass fiber sheet 109 and creates patterns or designs 105 on the surface 101a of the transparent or translucent particulates 102. Screen printing or any other known color or pattern and art transfer process may be applied to print patterns or designs 105 on the glass fiber sheet 109. The color pigments deposited on the glass fiber sheet 109 in a decorative fashion are seen through the transparent top layer 101 of transparent or translucent particulates 102, thereby providing decorative effects.

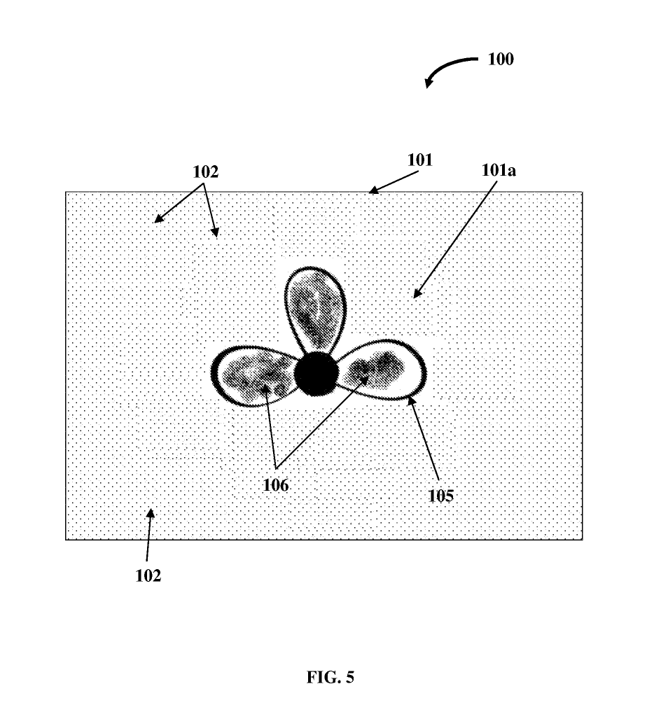

FIG. 5 exemplarily illustrates a top orthogonal view of an artificial stone laminate decorated by placing a glass fiber sheet 109 selectively deposited with a coloring material 106 carried in a resin in the form of a floral design 105 over a thin layer 101 of transparent or translucent particulates 102, for example, quartz particles.

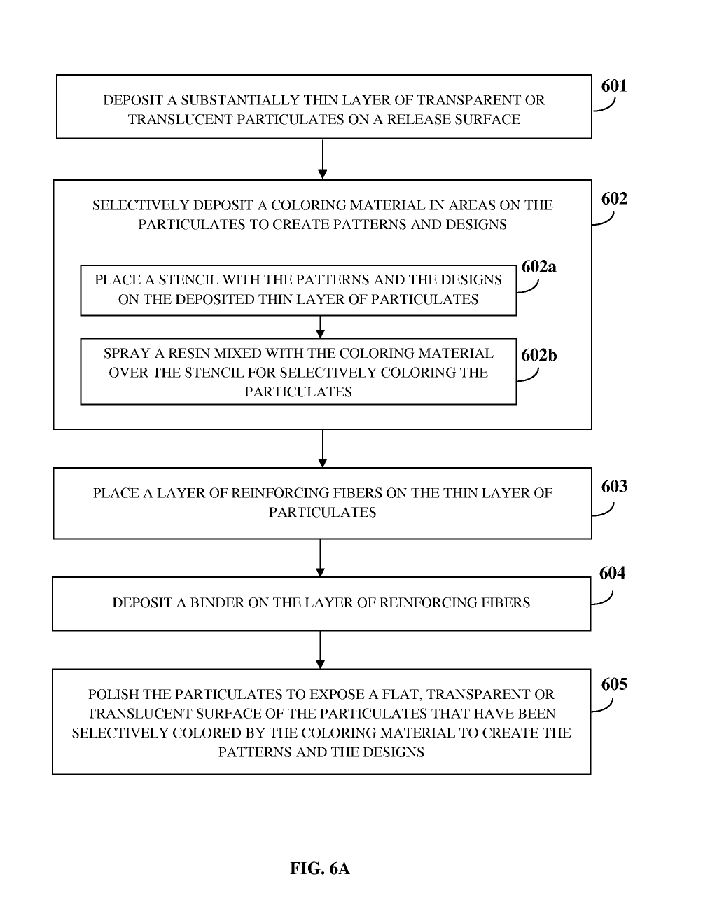

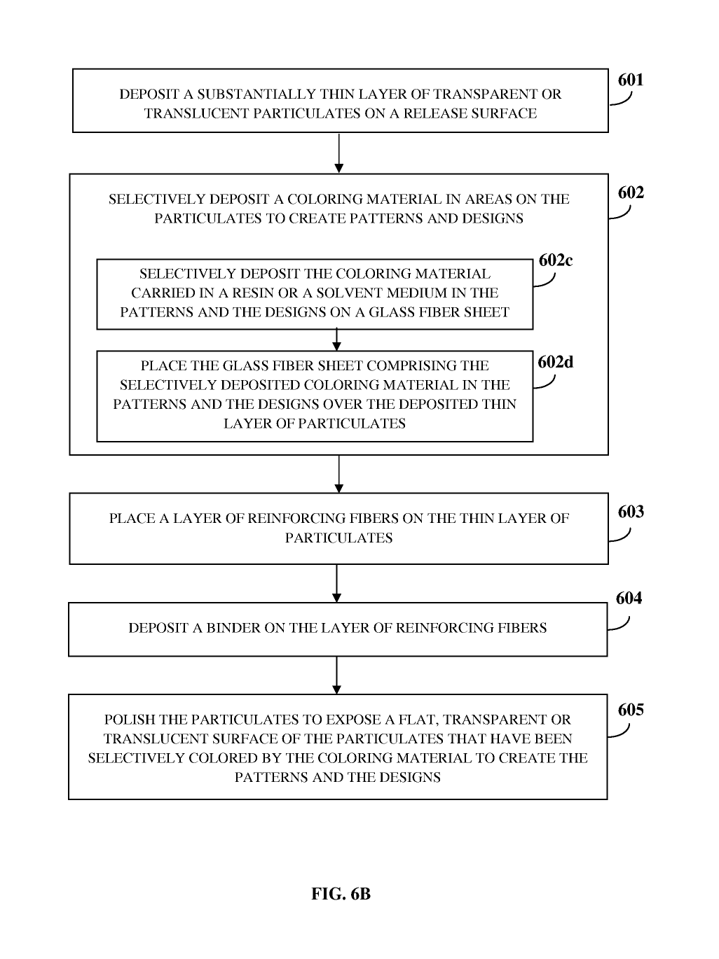

FIGS. 6A-6B exemplarily illustrate methods for decorating an artificial stone laminate 100 exemplarily illustrated in FIG. 1. In the methods disclosed herein, a substantially thin layer 101 of transparent or translucent particulates 102 is deposited 601 on a release surface. A coloring material 106 that imparts color and/or contrast is selectively deposited 602 in areas on the transparent or translucent particulates 102 to create patterns or designs 105. The coloring material 106 comprises, for example, one or more of color pigments, phosphorescent pigments, and metallic pigments.

In an embodiment exemplarily illustrated in FIG. 6A, the selective deposition 602 of the coloring material 106 on the transparent or translucent particulates 102 comprises placing 602a a stencil 108 with the patterns or designs 105 on the deposited thin layer 101 of transparent or translucent particulates 102 and spraying 602b a resin mixed with the coloring material 106 over the stencil 108 using a spray 107 as exemplarily illustrated in FIG. 2, for selectively coloring the transparent or translucent particulates 102.

In another embodiment exemplarily illustrated in FIG. 6B, the selective deposition 602 of the coloring material 106 on the transparent or translucent particulates 102 comprises selectively depositing 602c the coloring material 106 carried in a resin or a solvent medium in the patterns or designs 105 on a glass fiber sheet 109 as exemplarily illustrated in FIG. 4, and placing 602d the glass fiber sheet 109 comprising the selectively deposited coloring material 106 in the patterns or designs 105 over the deposited thin layer 101 of transparent or translucent particulates 102.

A layer 103 of reinforcing fibers 104 is placed 603 on the thin layer 101 of transparent or translucent particulates 102. A binder is deposited 604 on the layer 103 of reinforcing fibers 104 for filling the gaps between the transparent or translucent particulates 102 and for binding the reinforcing fibers 104 to the transparent or translucent particulates 102. In an embodiment, vacuum and pressure is applied to the deposited binder, the thin layer 101 of transparent or translucent particulates 102, and the layer 103 of reinforcing fibers 104 during and/or after the deposition of the binder. The transparent or translucent particulates 102 are polished 605 to expose a flat, transparent or translucent surface 101a of the transparent or translucent particulates 102 that have been selectively colored by the coloring material 106 to create the patterns or designs 105. In an embodiment, the surface 101a of the thin layer 101 of transparent or translucent particulates 102 is chemically modified for improving adhesion of the transparent or translucent particulates 102 with the binder. Top orthogonal views of the decorated artificial stone laminate 100 are exemplarily illustrated in FIG. 3 and FIG. 5.

A general overview of the manufacturing process is provided below. A layer 101 of transparent or translucent particulates 102, for example, quartz particles of uniform size is spread on a release surface. The layer 101 of particulates 102 on the release surface is vibrated. The vibration of the layer 101 of particulates 102 causes the particulates 102 to pack closely, touch one another adjacently in a horizontal plane, and achieve high surface coverage. In a first embodiment as exemplarily illustrated in FIGS. 2-3, a resin mixed with a pigment is sprayed over a stencil 108 using a spray 107, thereby selectively coloring the particulates 102. The binder fills gaps between the particulates 102 and binds the reinforcing fibers 104 to the particulates 102. The binder may be deposited on the single layer 101 of particulates 102, for example, by one of the processes of resin transfer molding, tape casting, spraying, etc. The same binder is used for both the top single layer 101 of particulates 102 and the rear layer 103 of reinforcing fibers 104. The top single layer 101 of particulates 102 and the rear layer 103 of reinforcing fibers 104 are cast with a binder matrix in situ resulting in the binder matrix being continuous between the two layers 101 and 103. When the binder cures, the surface 101a of the single layer 101 of particulates 102 is polished until the substantially largest sectional area of the particulates 102 is exposed. Furthermore, the method disclosed herein comprises application of vacuum and pressure to the deposited binder, the layer 101 of particulates 102, and the layer 103 of reinforcing fibers 104, for example, during and/or after the deposition of the binder. The application of vacuum and/or pressure eliminates formation of air bubbles in the artificial stone laminate 100.

The surface 101a of the single layer 101 of transparent or translucent quartz particulates 102 is chemically modified for improved adhesion with the binder. The quartz particulates 102 may be treated with an organofunctional coupling agent for better adhesion between the large quartz particulates 102, and with the binder and the reinforcing fibers 104. The binder is, for example, a polyester resin. The organofunctional coupling agent is, for example, an organofunctional silane. The release surface is vibrated whereby the large quartz particulates 102 are packed closely and achieve high surface coverage. The binder, for example, the polyester resin is deposited with a high concentration of solid filler. The binder fills the gaps between the large quartz particulates 102.

The artificial stone laminate 100 disclosed herein is thin, flexible, and lightweight and is used as an architectural surfacing material. Examples of the application of the artificial stone laminate 100 disclosed herein comprises surfacing of kitchen countertops, wall claddings, doors, tabletops, wardrobes, shelves, work-tops, counters, wall linings, column claddings, storage units, lift linings, store fittings, displays, vanity units, cubicles, check out desks, office partitions, and other home and office furniture.

The following example illustrates a method of manufacturing an ornamented artificial stone laminate 100 and the composition of the ornamented artificial stone laminate 100. A mix of quartz particulates 102 of substantially a single size with the size of the mix of the quartz particulates 102 ranging, for example, between about 1.4 mm and about 1.6 mm is deposited on a release surface, for example, a silicone rubber sheet of size 4 ft×8 ft placed on a metal work bench. A single layer 101 of quartz particulates 102 is deposited on the silicone rubber sheet placed on the metal work bench and the metal work bench is gently vibrated with an asymmetrically loaded shaft of a motor until the quartz particulates 102 are packed together, and touch one another adjacently. Vertical overlap of the quartz particulates 102 is avoided. The vertical overlap of the quartz particulates 102 would undesirably result in a thicker and uneven section. In a first embodiment, a stencil 108 with a floral template design 105 is placed over the layer 101 of quartz particulates 102. A polyester resin with a high 45% styrene content, thereby with reduced viscosity, with a 3% by weight red metallic oxide pigment, is sprayed on the stencil 108 using a spray 107 for selectively coloring the quartz particulates 102 to create a colored floral design 105.

A layer 103 of reinforcing fibers 104, for example, a chopped strand mat of density 900 grams per square meter is placed on the single layer 101 of quartz particulates 102. A binder comprising an isothalic neo pentyl glycol polyester resin, styrene, 1% by weight of a white pigment, 2% by weight of a methyl ethyl ketone peroxide (MEKP) catalyst, and 0.2% by weight of dimethyl aniline (DMA) is deposited on the quartz particulates 102 and the layer 103 of reinforcing fibers 104 by either spraying or a resin transfer process. Vacuum is applied to the deposited binder, the single layer 101 of quartz particulates 102, and the layer 103 of reinforcing fibers 104 after the deposition of the binder, for example, by enveloping the quartz particulates 102, the binder, and the reinforcing fibers 104 in a vacuum bag. After the mix cures, the cured composite is polished using diamond polishing bricks, until the substantially largest area of the quartz particulates 102 is exposed. This results in an artificial stone laminate 100 of an approximate thickness of about 1.5 mm with a red colored floral design 105 in a white background.

Small particulate quartz particles may also be interspersed in the gaps between the large quartz particulates 102. For example, 0.5 mm quartz particles may be interspersed in the gaps between large 1.4 mm-1.6 mm quartz particles. Further, fine powder aluminum trihydrate may be further added as a filler in the composite.

A lightweight core may optionally be provided as a backing to the layer 103 of reinforcing fibers 104. Examples of the lightweight core are a polyurethane foam, a honeycomb structure, a wood plank, etc. The honeycomb structure is, for example, a paper honeycomb, a reinforced plastic honeycomb, a plastic honeycomb, or an aluminum honeycomb.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A decorative artificial stone laminate, comprising:
a top layer of particulates colored in one or more predetermined patterns;
a rear layer of reinforcing fibers backing said particulates; and
a binder binding said particulates and said reinforcing fibers.

2. The decorative artificial stone laminate of claim 1, wherein said binder is a polyester resin with a filler.

3. The decorative artificial stone laminate of claim 1, wherein said binder is an acrylic resin.

4. The decorative artificial stone laminate of claim 1, wherein said reinforcing fibers comprise glass fibers.

5. The decorative artificial stone laminate of claim 1, wherein said particulates comprise quartz particles.

6. The decorative artificial stone laminate of claim 1, wherein said particulates comprise one or more of quartz particulates, metal pieces, transparent particulates coated with metal and colored glass, and any combination thereof.

7. A method for decorating an artificial stone laminate, comprising:
depositing a substantially thin layer of transparent or translucent particulates on a release surface;
selectively depositing a coloring material that imparts color and/or contrast in areas on said transparent or translucent particulates to create patterns and designs;
placing a layer of reinforcing fibers on said substantially thin layer of said transparent or translucent particulates;
depositing a binder on said layer of said reinforcing fibers, wherein said binder fills gaps between said transparent or translucent particulates and binds said reinforcing fibers to said transparent or translucent particulates; and
polishing said transparent or translucent particulates to expose a flat, transparent or translucent surface of said transparent or translucent particulates that have been selectively colored by said coloring material to create said patterns and said designs.

8. The method of claim 7, wherein said selective deposition of said coloring material on said transparent or translucent particulates comprises:
placing a stencil with said patterns and said designs on said deposited substantially thin layer of said transparent or translucent particulates; and
spraying a resin mixed with said coloring material over said stencil for selectively coloring said transparent or translucent particulates.

9. The method of claim 7, wherein said selective deposition of said coloring material on said transparent or translucent particulates comprises:
selectively depositing said coloring material carried in one of a resin and a solvent medium in said patterns and said designs on a glass fiber sheet; and
placing said glass fiber sheet comprising said selectively deposited coloring material in said patterns and said designs over said deposited substantially thin layer of said transparent or translucent particulates.

10. The method of claim 7, further comprising applying vacuum and pressure to said deposited binder, said substantially thin layer of said transparent or translucent particulates, and said layer of said reinforcing fibers during and/or after said deposition of said binder.

11. The method of claim 7, further comprising chemically modifying surface of said substantially thin layer of said transparent or translucent particulates for improving adhesion of said transparent or translucent particulates with said binder.

12. The method of claim 7, wherein said transparent or translucent particulates comprise quartz particles.

13. The method of claim 7, wherein said coloring material comprises one or more of color pigments, phosphorescent pigments, and metallic pigments.
